(19) United States
(12) Patent Application Publication
(10) Pub. No.: US 2019/0063878 A1
(43) Pub. Date: Feb. 28, 2019

(54) ANTI-BALLISTIC PANELS AND APPLICATIONS THEREOF

(71) Applicant: ShieldPro, LLC., Irvine, CA (US)

(72) Inventors: Peter MOWBRAY, Irvine, CA (US); Fred E PETERS, Irvine, CA (US)

(21) Appl. No.: 15/766,959

(22) PCT Filed: Oct. 7, 2016
(86) PCT No.: PCT/US2016/056174

§ 371 Date: Apr. 9, 2018

Related U.S. Application Data
(60) Provisional application No. 62/239,797, filed on Oct. 9, 2015.

(51) Int. Cl. F41H 5/04; F41H 5/06; F41H 5/26; F41H 5/013; B32B 5/18; B32B 5/24; B32B 21/10; B32B 21/04

(52) U.S. Cl. CPC F41H 5/04; F41H 5/0471; F41H 5/06; F41H 5/263; F41H 5/013; B32B 2571/02; B32B 5/245; B32B 21/10; B32B 21/047; F41H 5/0492; F41H 5/0407; B32B 5/18

(57) ABSTRACT

An Anti-Ballistic Panel having a first structural layer, a second structural layer, a first Anti-Ballistic layer disposed between the first structural layer and the second structural layer; and an elastomeric layer disposed between the first structural layer and the Anti-Ballistic layer is described. Applications of the Anti-Ballistic Panel are also described.

### FIELD OF INVENTION

This application relates to a construction of panels, more particularly panels having portions with Anti-Ballistic (e.g. “Ballistic Resistant”) properties and applications of the panels.

### BACKGROUND

“Bullet Resistant” is the process of making something capable of stopping a bullet or similar high velocity projectiles e.g. shrapnel. The term bullet resistance is often preferred because few, if any, practical materials provide complete protection against all types of bullets, or multiple hits in the same location. Bullet designs vary widely, not only according to the particular firearm used (e.g. a 9×19 mm Parabellum caliber hollow point handgun cartridge will have inferior penetration power compared to a 7.62×39 mm assault rifle cartridge), but also within individual cartridge designs. As a result, while some so-called “bullet-proof” panels may successfully prevent penetration by standard 7.62×39 mm bullets containing lead cores, the same panels may easily be defeated by 7.62×39 mm armor piercing bullets containing hardened steel penetrators.

Bullet-resistant materials, also called ballistic materials or, equivalently, Anti-Ballistic materials, are usually rigid, but may be supple. They may be complex, such as KEVLAR® LEXAN®, and carbon fiber composite materials, or they may be basic and simple, such as steel or titanium. Bullet resistant materials are often used in law enforcement and military applications, to protect personnel from death or serious injuries.

There is a growing need for methods of self-protection in an increasingly wide variety of locations. In the modem world, crimes and attacks committed by persons with guns are an ever more common occurrence. In the past, police personnel and military personnel have been the primary targets of gunfire, which has been directed toward them during work or duty. Because of this continual risk of harm, bullet resistant vests and shields have been developed which may be deployed or worn on the user's body as a protective component of their work attire. Such devices, when employed for protection against weapons fire have worked fairly well in preventing a high velocity bullet or shell from penetrating the wearer's body since the velocity is slowed considerably.

It has been made evident by recent shootings, such as Fort Hood, there may be a need for additional means of self-protection. This mass shooting took place on Nov. 5, 2009, at Fort Hood, the most populous U.S. military installation in the world, located just outside Killeen, Tex. In the course of the shooting, a single gunman killed 13 people and wounded 29 others. According to witnesses, some individuals attempted to stop the shooter, either by charging him or throwing a chair at him, but were mortally wounded in the process.

It was additionally made evident at Columbine High School in Colorado in 1999 that similar occurrences may also occur in other locations where civilians, including children may be affected and there is an increased need for self-protection. Anti-Ballistic furniture or barriers should blend into a conventional room's appearance, where people gather such as meeting rooms, classrooms, libraries, or cafeterias and avoid the rooms taking on the appearance of military bunkers.

New materials and improvements of manufacturing processes may allow items such ballistic-proof panels for use in furniture and moveable barriers to become a practical item. Previously, bullet-resistant vests have been constructed by applying multiple layers of fabric woven from an aramid fiber together, which is sold by Du Pont under the Trademark KEVLAR. It can be used in a flexible state or laminated in a more rigid configuration. The success of the product is attained by multiple layers of the semi-impregnable flexible structure. This material combines high penetration resistance with lightness and flexibility but no one has endeavored to manufacture usable panels for inclusion in rolling or barriers, wall paneling, cubical dividers, or office furniture items using these materials.

As should be understood that embodiments of the present application are not limited to the details of construction and to the arrangement of the components or the steps set forth in the following description or illustrated in the drawings. The various alternatives or combinations of the features shown or described herein may be incorporated into other embodiments and practiced and carried out in various ways, which might be apparent to those skilled in the art once the information herein is reviewed. Also, it is to be understood that the phraseology and terminology employed herein are for the purpose of description, and should not be regarded as limiting in any fashion. As such, those skilled in the art will appreciate that the conception upon which this disclosure is based may readily be utilized as a basis for designing other furniture type ballistic shields for carrying out the several purposes of the present disclosed device and method. It is important, therefore, that the embodiments, objects, and claims herein, be regarded as including such equivalent construction and methodology insofar as they do not depart from the spirit and scope of the present invention.

### SUMMARY

Example implementations of the present application may include an Anti-Ballistic Panel including a first structural layer, a second structural layer, a first Anti-Ballistic layer disposed between the first structural layer and the second structural layer, and an elastomeric layer disposed between the first structural layer and the Anti-Ballistic layer.

Another example implementation of the present application may include a moveable barrier including an internal frame and at least one Anti-Ballistic Panel attached to the internal frame. Further, in some example implementations, the Anti-Ballistic Panel may include a first structural layer, a second structural layer, a first Anti-Ballistic layer disposed between the first structural layer and the second structural layer, and an elastomeric layer disposed between the first structural layer and the Anti-Ballistic layer.

Additionally, the Anti-Ballistic core portions of the Anti-Ballistic Panels may be fabricated using not only Aramid fibers and KEVLAR® from DuPont, but also polyethylene fibers and GOLD SHIELD®, which is a KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in ballistic material.

Moreover, both of the Honeywell materials can be used as layered soft armor as well as hard armor when they are autoclaved or compression molded into Anti-Ballistic components for construction of the Anti-Ballistic Panels. Other similar materials of like purpose and function are also anticipated by this disclosure.

Other aspects of implementations of the present application may be discussed or may become apparent in view of the following description of embodiments of the present application and the figures enclosed with this application. In this respect, it is to be understood that the design is not limited in its application to the details of construction and to the arrangement of the components set forth in the following description or illustrated in the drawings. In addition, it is to be understood that the phraseology and terminology employed herein are for the purpose of description and should not be regarded as limiting.

While the description of the Anti-Ballistic Panels has been made herein with reference to particular embodiments thereof, a latitude of modifications, various changes and substitutions are intended in the foregoing disclosure, and it will be appreciated that in some instance some features of the design will be employed without a corresponding use of other features without departing from the scope of the invention as set forth.

### BRIEF DESCRIPTION OF THE DRAWINGS

The accompanying drawings, which are incorporated in and form a part of this specification, illustrate embodiments of the Anti-Ballistic Panels and together with the description, serve to explain the aspects of this application.

FIG. 1 is a cross-section of an Anti-Ballistic Panel according to a first embodiment of the present application.

FIG. 2 is a cross-section of an Anti-Ballistic Panel according to a second embodiment of the present application.

FIG. 3 is a cross-section of an Anti-Ballistic Panel according to a third embodiment of the present application.

FIG. 4 is a front view of a movable barrier that could use an Anti-Ballistic Panel according to an embodiment of the present application.

FIG. 5 is an exploded view of the movable barrier of FIG. 4.

FIGS. 6 and 7 are cross-sectional views of the movable barrier of FIG. 4.

FIG. 8 is an enlarged view of a portion (VIII) of FIG. 7.

FIGS. 9 and 10 are perspective views of an example implementation of the movable barrier of FIG. 4.

FIG. 11 illustrates an internal view of a portion (XI) of FIG. 10 beneath the skirt of the movable barrier.

FIGS. 12 and 13 are perspective views of a movable barrier according to a second embodiment of the present application.

FIG. 14 is a perspective view of furniture using the Anti-Ballistic Panels according to embodiments of the present movable barrier.

FIG. 15 is a cross-section of an Anti-Ballistic Panel according to a fourth embodiment of the present application.

### DETAILED DESCRIPTION OF EMBODIMENTS

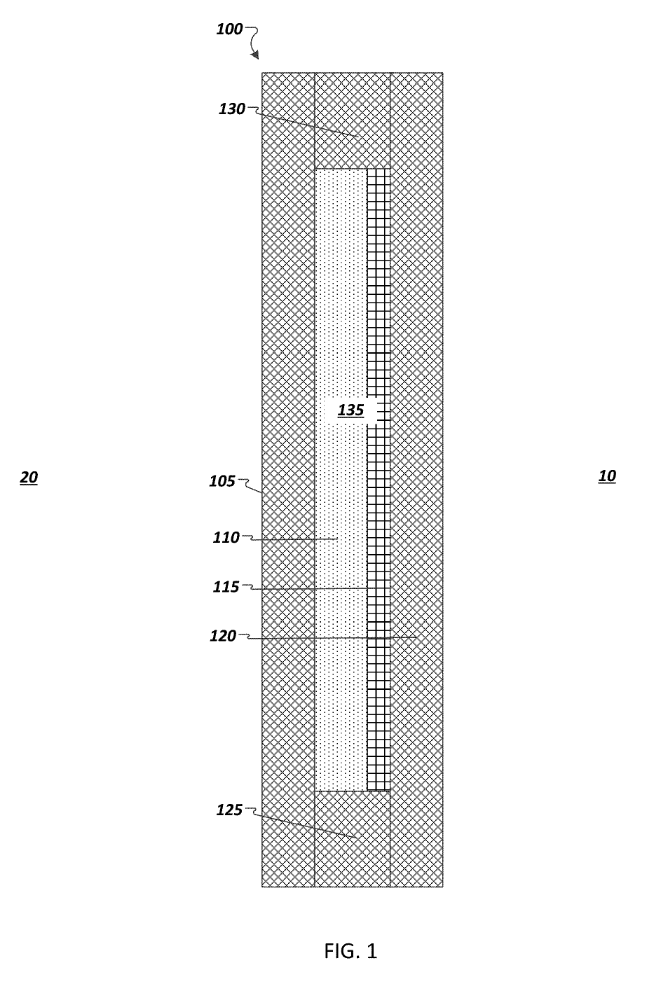

FIG. 1 is a cross-section of an Anti-Ballistic Panel 100 according to a first embodiment of the present application. As illustrated, one side 10 of the Anti-Ballistic Panel 100 may be considered an exterior side or active side that may be oriented outward or toward an anticipated ballistic source. For example, the exterior side 10 may be oriented to face out from a wall or may face outward from furniture incorporating the Anti-Ballistic Panel 100. Conversely, the other side 20 of the Anti-Ballistic Panel 100 may be considered an interior side or passive side that may be oriented inward or away from an anticipated ballistic source. For example, the interior side 20 may be oriented to face inward toward a wall or may face inward from furniture incorporating the Anti-Ballistic Panel 100.

The Anti-Ballistic Panel 100 may include a first structural layer 105 providing structure and rigidity to the panel. In some embodiments, the first structural layer 105 may be formed from wood or any other material that may be apparent to a person of ordinary skill in the art to use for structural support. Further, in some embodiments, the first structural layer 105 may be formed from compressed wood, “MDF” or medium density fiberboard, plywood or other engineered wood materials that may be apparent to a person of ordinary skill in the art. Such materials may provide an increased resistance to warping and/or fracturing or splintering when hit directly with bullets. The thickness of the first structural layer 105 is not particularly limited and may be any thickness that may be apparent to a person of ordinary skill in the art.

The Anti-Ballistic Panel 100 may also include an elastomeric layer 110 oriented on an exterior side of the first structural layer 105. In some example embodiments, the elastomeric layer 110 may be a polyethylene foam material or other closed-cell foam material that may be apparent to a person ordinary skill in the art. Further in some embodiments, the elastomeric layer 110 may have a thickness of one (1) inch or thicker. However, embodiments of the present application are not limited to this configuration.

The Anti-Ballistic Panel 100 may also include an Anti-Ballistic Portion or Anti-Ballistic layer 115 oriented on an exterior side of the elastomeric layer 110. In some embodiments, the Anti-Ballistic Portion 115 may be formed from aramid fibers. For example the Anti-Ballistic Portion 115 may be formed from plurality layers, each layer being formed from aramid fibers laid parallel to each other. Further, adjacent layers of the Anti-Ballistic Portion 115 may be oriented such that the fibers of the adjacent layers are angled with respect to each other. For example, fibers of adjacent layers may form a 90° with respect to each other. In other embodiments, the angle may be an angle other than 90° (e.g. 45°, 60°, 75°, or any other angle that may be apparent to a person of ordinary skill in the art.

It must be fully understood at this time that different Anti-Ballistic materials can be used for the purpose of constructing the Anti-Ballistic Portion 115 including a variety of soft materials along with hard surfaced resin impregnated laminated Anti-Ballistic materials some of which are sold by Du Pont under the registered trademark KEVLAR® and will still remain within the scope of this application. Additionally, the Anti-Ballistic Portions of the Anti-Ballistic Portion 115 may be fabricated using not only aramid fibers and KEVLAR® from DuPont, but also polyethylene fibers and GOLD SHIELD®, which is a KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in ballistic material. Moreover, both of the Honeywell materials can be used as layered soft armor as well as hard armor when they are autoclaved or compression molded into Anti-Ballistic components for construction of the Anti-Ballistic Portion 115, as shown and described. Other similar materials of like purpose and function are also anticipated by this disclosure.

In some embodiments, the Anti-Ballistic Portion 115 may have a thickness of ¼ (0.25) inch. However, embodiments of the present application are not limited to this configuration and may have other configurations that may be apparent to a person of ordinary skill in the art.

The Anti-Ballistic Panel 100 may also include a second structural layer 120 on an exterior side of the Anti-Ballistic Portion 115 to provide structure and rigidity to the Anti-Ballistic Panel 100. In some embodiments, the second structural layer 120 may be formed from wood or any other material that may be apparent to a person of ordinary skill in the art to use for structural support. Further, in some embodiments, the second structural layer 120 may be formed from compressed wood, plywood or other engineered wood material that may be apparent to a person of ordinary skill in the art. Such materials may provide an increased resistance to warping. The thickness of the second structural layer 120 is not particularly limited and may be any thickness that may be apparent to a person of ordinary skill in the art.

In some implementations of the Anti-Ballistic Panel 100, the first structural layer 105 and the second structural layer 120 may be longer then the elastomeric layer 110 and the Anti-Ballistic Portion 115, as illustrated. In such implementations, a first end piece 125 and a second end piece 130 may be provided at each end of the Anti-Ballistic Panel 100 such that the elastomeric layer 110 and the Anti-Ballistic Portion 115 are fully enclosed in a hollow 135 defined by the first and second structural layers 105, 110 and the first and second end pieces 125, 130. In some implementations, the first and second structural layers 105, 110 may each be attached to the first and second end pieces 125, 130 using an adhesive. For example, a glue, adhesive, or epoxy such as a two-part epoxy may be used. In other example implementations, the first and structural layers 105, 110 may be attached to the first and second end pieces 125, 130 using screws, binding posts, or any other attachment mechanism that may be apparent to a person of ordinary skill in the art.

In some implementations, the elastomeric layer 110 and the Anti-Ballistic Portion 115 may “float” in hollow 135. In other words, the elastomeric layer 110 may not be attached to any one of: the first structural layer 105, the second structural layer 120, the first end piece 125, the second end piece 130 or the Anti-Ballistic Portion 115, but still be retained within the hollow 135. Similarly, Anti-Ballistic Portion 115 may not be attached to any one of: the first structural layer 105, the second structural layer 120, the first end piece 125, the second end piece 130 or the elastomeric layer 110, but still be retained within the hollow 135. In these configurations, the size of the hollow 135 may be sized such that the elastomeric layer 110 and the Anti-Ballistic Portion 115 are snugly held in place. Further, in some configurations, the hollow 135 may be sized such that the elastomeric layer 110 is slightly compressed (5-10% or more) when the Anti-Ballistic Panel 100 is fully assembled.

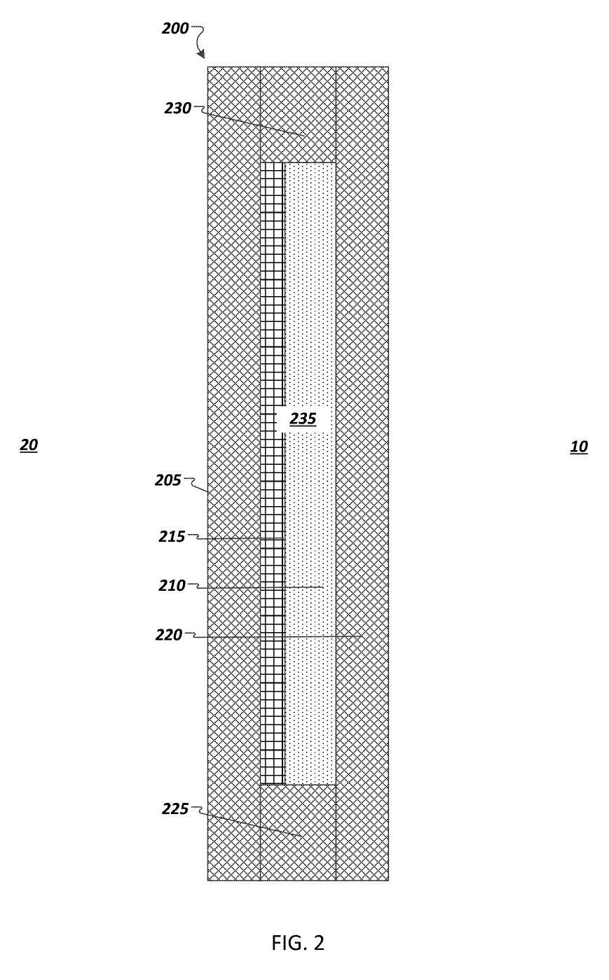

FIG. 2 is a cross-section of an Anti-Ballistic Panel 200 according to a second embodiment of the present application. As illustrated, one side 10 of the Anti-Ballistic Panel 200 may be considered an exterior side or active side that may be oriented outward or toward an anticipated ballistic source. For example, the exterior side 10 may be oriented to face out from a wall or may face outward from furniture incorporating the Anti-Ballistic Panel 200. Conversely, the other side 20 of the Anti-Ballistic Panel 200 may be considered an interior side or passive side that may be oriented inward or away from an anticipated ballistic source. For example, the interior side 20 may be oriented to face inward toward a wall or may face inward from furniture incorporating the Anti-Ballistic Panel 200.

The Anti-Ballistic Panel 200 may include a first structural layer 205 providing structure and rigidity to the panel. In some embodiments, the first structural layer 205 may be formed from wood or any other material that may be apparent to a person of ordinary skill in the art to use for structural support. Further, in some embodiments, the first structural layer 205 may be formed from compressed wood, medium density fiberboard, plywood or other engineered wood materials that may be apparent to a person of ordinary skill in the art. Such materials may provide an increased resistance to warping. The thickness of the first structural layer 205 is not particularly limited and may be any thickness that may be apparent to a person of ordinary skill in the art.

The Anti-Ballistic Panel 200 may also include an Anti-Ballistic Portion or Anti-Ballistic layer 215 oriented on an exterior side of the first structural layer 205. In some embodiments, the Anti-Ballistic Portion 215 may be formed from aramid fibers. For example the Anti-Ballistic Portion 215 may be formed from plurality layers, each layer being formed from aramid fibers laid parallel to each other. Further, adjacent layers of the Anti-Ballistic Portion 215 may be oriented such that the fibers of the adjacent layers are angled with respect to each other. For example, fibers of adjacent layers may form a 90° with respect to each other. In other embodiments, the angle may be an angle other than 90° (e.g. 45°, 60°, 75°, or any other angle that may be apparent to a person of ordinary skill in the art.

It must be fully understood at this time that different Anti-Ballistic materials can be used for the purpose of constructing the Anti-Ballistic Portion 215 including a variety of soft materials along with hard surfaced resin impregnated laminated Anti-Ballistic materials some of which are sold by Du Pont under the registered trademark KEVLAR® and will still remain within the scope of this application. Additionally, the Anti-Ballistic Portions of the Anti-Ballistic Portion 215 may be fabricated using not only aramid fibers and KEVLAR® from DuPont, but also polyethylene fibers and GOLD SHIELD®, which is a KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in ballistic material. Moreover, both of the Honeywell materials can be used as layered soft armor as well as hard armor when they are autoclaved or compression molded into Anti-Ballistic components for construction of the Anti-Ballistic Portion 215, as shown and described. Other similar materials of like purpose and function are also anticipated by this disclosure.

In some embodiments, the Anti-Ballistic Portion 215 may have a thickness of ¼ (0.25) inch. However, embodiments of the present application are not limited to this configuration and may have other configurations that may be apparent to a person of ordinary skill in the art.

The Anti-Ballistic Panel 200 may also include an elastomeric layer 210 oriented on an exterior side of the Anti-Ballistic Portion 215. In some example embodiments, the elastomeric layer 210 may be a polyethylene foam material or other closed-cell foam material that may be apparent to a person ordinary skill in the art. Further in some embodiments, the elastomeric layer 210 may have a thickness of one (1) inch or thicker. However, embodiments of the present application are not limited to this configuration.

The Anti-Ballistic Panel 200 may also include a second structural layer 220 on an exterior side of the elastomeric layer 210 to provide structure and rigidity to the Anti-Ballistic Panel 200. In some embodiments, the second structural layer 220 may be formed from wood or any other material that may be apparent to a person of ordinary skill in the art to use for structural support. Further, in some embodiments, the second structural layer 220 may be formed from compressed wood, plywood or other engineered wood material that may be apparent to a person of ordinary skill in the art. Such materials may provide an increased resistance to warping. The thickness of the second structural layer 220 is not particularly limited and may be any thickness that may be apparent to a person of ordinary skill in the art.

In some implementations of the Anti-Ballistic Panel 200, the first structural layer 205 and the second structural layer 220 may be longer then the elastomeric layer 210 and the Anti-Ballistic Portion 215, as illustrated. In such implementations, a first end piece 225 and a second end piece 230 may be provided at each end of the Anti-Ballistic Panel 200 such that the elastomeric layer 210 and the Anti-Ballistic Portion 215 are fully enclosed in a hollow 235 defined by the first and second structural layers 205, 210 and the first and second end pieces 225, 230. In some implementations, the first and second structural layers 205, 210 may each be attached to the first and second end pieces 225, 230 using an adhesive. For example, a glue, adhesive, or epoxy such as a two-part epoxy may be used. In other example implementations, the first and structural layers 205, 210 may be attached to the first and second end pieces 225, 230 using screws, binding posts, or any other attachment mechanism that may be apparent to a person of ordinary skill in the art.

In some implementations, the elastomeric layer 210 and the Anti-Ballistic Portion 215 may “float” in hollow 235. In other words, the elastomeric layer 210 may not be attached to any one of: the first structural layer 205, the second structural layer 220, the first end piece 225, the second end piece 230 or the Anti-Ballistic Portion 215, but still be retained within the hollow 235. Similarly, Anti-Ballistic Portion 215 may not be attached to any one of: the first structural layer 205, the second structural layer 220, the first end piece 225, the second end piece 230 or the elastomeric layer 210, but still be retained within the hollow 235. In these configurations, the size of the hollow 235 may be sized such that the elastomeric layer 210 and the Anti-Ballistic Portion 215 are snugly held in place. Further, in some configurations, the hollow 235 may be sized such that the elastomeric layer 210 is slightly compressed (5-10% or more) when the Anti-Ballistic Panel 200 is fully assembled.

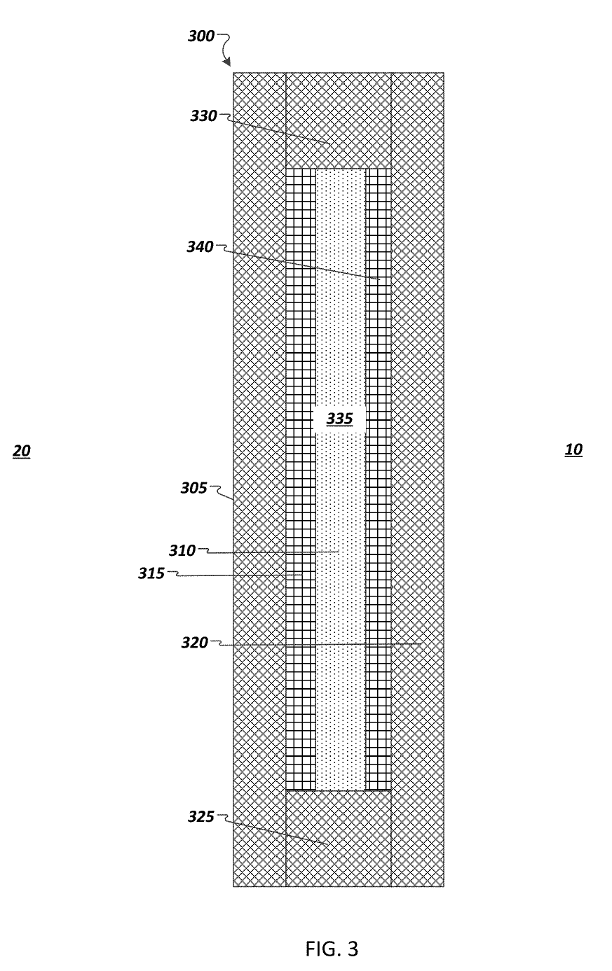

FIG. 3 is a cross-section of an Anti-Ballistic Panel 300 according to a third embodiment of the present application. As illustrated, one side 10 of the Anti-Ballistic Panel 300 may be considered an exterior side or active side that may be oriented outward or toward an anticipated ballistic source. For example, the exterior side 10 may be oriented to face out from a wall or may face outward from furniture incorporating the Anti-Ballistic Panel 300. Conversely, the other side 20 of the Anti-Ballistic Panel 300 may be considered an interior side or passive side that may be oriented inward or away from an anticipated ballistic source. For example, the interior side 20 may be oriented to face inward toward a wall or may face inward from furniture incorporating the Anti-Ballistic Panel 300.

The Anti-Ballistic Panel 300 may include a first structural layer 305 providing structure and rigidity to the panel. In some embodiments, the first structural layer 305 may be formed from wood or any other material that may be apparent to a person of ordinary skill in the art to use for structural support. Further, in some embodiments, the first structural layer 305 may be formed from compressed wood, medium density fiberboard, plywood or other engineered wood material that may be apparent to a person of ordinary skill in the art. Such materials may provide an increased resistance to warping. The thickness of the first structural layer 305 is not particularly limited and may be any thickness that may be apparent to a person of ordinary skill in the art.

The Anti-Ballistic Panel 300 may also include a first Anti-Ballistic Portion or Anti-Ballistic layer 315 oriented on an exterior side of the first structural layer 305. In some embodiments, the first Anti-Ballistic Portion 315 may be formed from aramid fibers. For example the first Anti-Ballistic Portion 315 may be formed from plurality layers, each layer being formed from aramid fibers laid parallel to each other. Further, adjacent layers of the first Anti-Ballistic Portion 315 may be oriented such that the fibers of the adjacent layers are angled with respect to each other. For example, fibers of adjacent layers may form a 90° with respect to each other. In other embodiments, the angle may be an angle other than 90° (e.g. 45°, 60°, 75°, or any other angle that may be apparent to a person of ordinary skill in the art.

It must be fully understood at this time that different Anti-Ballistic materials can be used for the purpose of constructing the first Anti-Ballistic Portion 315 including a variety of soft materials along with hard surfaced resin impregnated laminated Anti-Ballistic materials some of which are sold by Du Pont under the registered trademark KEVLAR® and will still remain within the scope of this application. Additionally, the first Anti-Ballistic Portion of the Anti-Ballistic Portion 315 may be fabricated using not only aramid fibers and KEVLAR® from DuPont, but also polyethylene fibers and GOLD SHIELD®, which is a KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in ballistic material. Moreover, both of the Honeywell materials can be used as layered soft armor as well as hard armor when they are autoclaved or compression molded into Anti-Ballistic components for construction of the first Anti-Ballistic Portion 315, as shown and described. Other similar materials of like purpose and function are also anticipated by this disclosure.

In some embodiments, the first Anti-Ballistic Portion 315 may have a thickness of ¼ (0.25) inch. However, embodiments of the present application are not limited to this configuration and may have other configurations that may be apparent to a person of ordinary skill in the art.

The Anti-Ballistic Panel 300 may also include an elastomeric layer 310 oriented on an exterior side of the first Anti-Ballistic Portion 315. In some example embodiments, the elastomeric layer 310 may be a polyethylene foam material or other closed-cell foam material that may be apparent to a person ordinary skill in the art. Further in some embodiments, the elastomeric layer 310 may have a thickness of one (1) inch or thicker. However, embodiments of the present application are not limited to this configuration.

The Anti-Ballistic Panel 300 may also include a second Anti-Ballistic Portion or Anti-Ballistic layer 340 oriented on an exterior side of the elastomeric layer 310. In some embodiments, the second Anti-Ballistic Portion 340 may be formed from aramid fibers. For example the second Anti-Ballistic Portion 340 may be formed from plurality layers, each layer being formed from aramid fibers laid parallel to each other. Further, adjacent layers of the second Anti-Ballistic Portion 340 may be oriented such that the fibers of the adjacent layers are angled with respect to each other. For example, fibers of adjacent layers may form a 90° with respect to each other. In other embodiments, the angle may be an angle other than 90° (e.g. 45°, 60°, 75°, or any other angle that may be apparent to a person of ordinary skill in the art.

It must be fully understood at this time that different Anti-Ballistic materials can be used for the purpose of constructing the second Anti-Ballistic Portion 340 including a variety of soft materials along with hard surfaced resin impregnated laminated Anti-Ballistic materials some of which are sold by Du Pont under the registered trademark KEVLAR® and will still remain within the scope of this application. Additionally, the Anti-Ballistic Portions of the second Anti-Ballistic Portion 340 may be fabricated using not only aramid fibers and KEVLAR® from DuPont, but also polyethylene fibers and GOLD SHIELD®, which is a KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in ballistic material. Moreover, both of the Honeywell materials can be used as layered soft armor as well as hard armor when they are autoclaved or compression molded into Anti-Ballistic components for construction of the second Anti-Ballistic Portion 340, as shown and described. Other similar materials of like purpose and function are also anticipated by this disclosure.

In some embodiments, the second Anti-Ballistic Portion 340 may have a thickness of ¼ (0.25) inch. However, embodiments of the present application are not limited to this configuration and may have other configurations that may be apparent to a person of ordinary skill in the art.

The Anti-Ballistic Panel 300 may also include a second structural layer 320 on an exterior side of second Anti-Ballistic Portion 340 to provide structure and rigidity to the Anti-Ballistic Panel 300. In some embodiments, the second structural layer 320 may be formed from wood or any other material that may be apparent to a person of ordinary skill in the art to use for structural support. Further, in some embodiments, the second structural layer 320 may be formed from compressed wood, plywood or other engineered wood material that may be apparent to a person of ordinary skill in the art. Such materials may provide an increased resistance to warping. The thickness of the second structural layer 320 is not particularly limited and may be any thickness that may be apparent to a person of ordinary skill in the art.

In some implementations of the Anti-Ballistic Panel 300, the first structural layer 305 and the second structural layer 320 may be longer then the elastomeric layer 310 and the Anti-Ballistic Portion 315, as illustrated. In such implementations, a first end piece 325 and a second end piece 330 may be provided at each end of the Anti-Ballistic Panel 300 such that the elastomeric layer 310, the first Anti-Ballistic Portion 315, and the second Anti-Ballistic Portion 340 are fully enclosed in a hollow 335 defined by the first and second structural layers 305, 310 and the first and second end pieces 325, 330. In some implementations, the first and second structural layers 305, 310 may each be attached to the first and second end pieces 325, 330 using an adhesive. For example, a glue, adhesive, or epoxy such as a two-part epoxy may be used. In other example implementations, the first and structural layers 305, 310 may be attached to the first and second end pieces 325, 330 using screws, binding posts, or any other attachment mechanism that may be apparent to a person of ordinary skill in the art.

In some implementations, the elastomeric layer 310, the first Anti-Ballistic Portion 315, and the second Anti-Ballistic Portion 340 may “float” in hollow 335. In other words, the elastomeric layer 310 may not be attached to any one of: the first structural layer 305, the second structural layer 320, the first end piece 325, the second end piece 330, the first Anti-Ballistic Portion 315, or the second Anti-Ballistic Portion 340, but still is retained within the hollow 335. Similarly, the first Anti-Ballistic Portion 315 may not be attached to any one of: the first structural layer 305, the second structural layer 320, the first end piece 325, the second end piece 330, or the elastomeric layer 310, but still is retained within the hollow 335. Further, the second Anti-Ballistic Portion 340 may not be attached to any one of: the first structural layer 305, the second structural layer 320, the first end piece 325, the second end piece 330, or the elastomeric layer 310, but still is retained within the hollow 335. In these configurations, the size of the hollow 335 may be sized such that the elastomeric layer 310, the first Anti-Ballistic Portion 315, and the second Anti-Ballistic Portion 340 are snugly held in place. Further, in some configurations, the hollow 335 may be sized such that the elastomeric layer 310 is slightly compressed (5-10% or more) when the Anti-Ballistic Panel 300 is fully assembled.

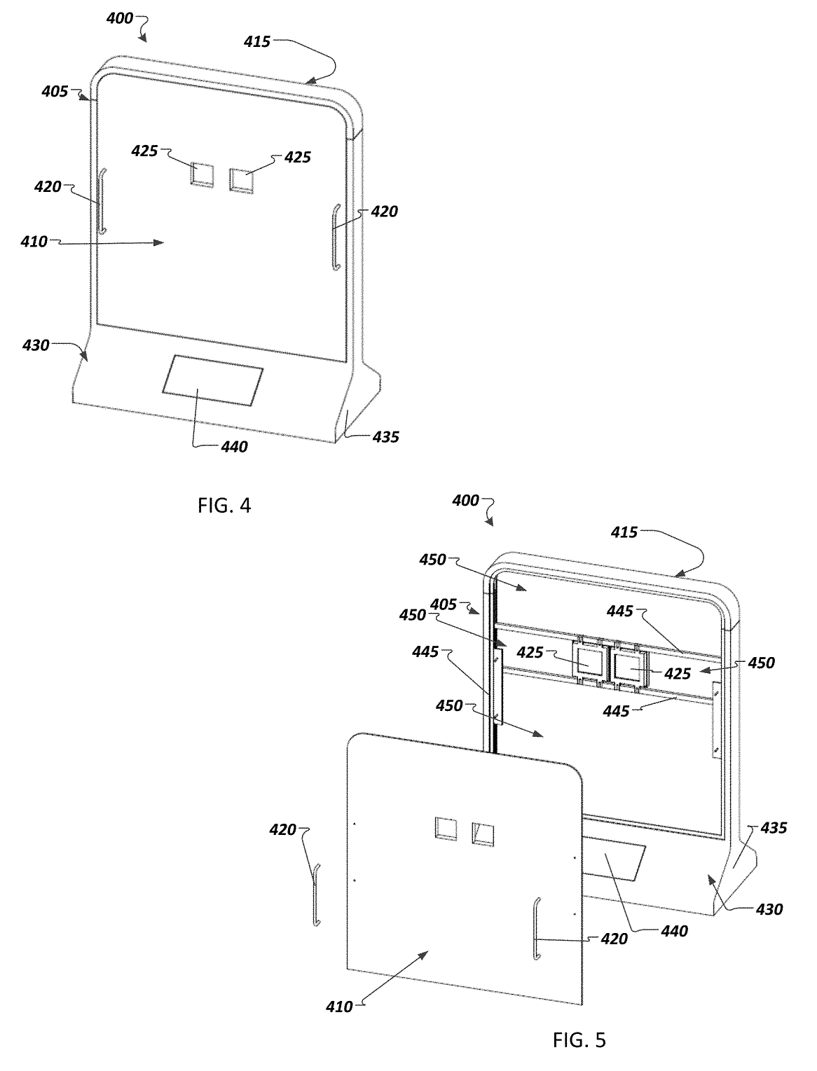

Embodiments of the Anti-Ballistic Panels 100, 200, 300 illustrated in FIGS. 1-3 and discussed above can be used in a variety of applications. FIGS. 4-15 discussed below illustrate applications of example embodiments of Anti-Ballistic Panels according to the present application.

FIG. 4 is a front view of a movable barrier 400 that could use an Anti-Ballistic Panel according to an embodiment of the present application. For example, the Anti-Ballistic Panels 100, 200, 300 illustrated in FIGS. 1-3 and discussed above could be incorporated into the illustrated movable barrier 400. The Anti-Ballistic Panel may be incorporated into the interior of the rolling barrier 400 as discussed below.

The movable barrier 400 may include a vertical portion 405 forming a barrier with a front surface 410 and a back surface 415. The front and back surfaces 410 and 415 may have a smooth or textured surface formed of wood, plastic, ceramic, metal or any other material that may be apparent to a person of ordinary skill in the art. Additionally, the front and back surfaces 410 and 415 may also be covered by fabric, wall paper, printed graphics, paint, or any other surface treatment that may be apparent to a person of ordinary skill in the art. Further, the front and back surfaces 410 and 415 may also include magnets, push pin or bulletin board material, or may be treated to provide a writing surface (such as a dry erase board surface, or a chalkboard surface).

The vertical portion 405 of the movable barrier 400 may also include one or more handles 420. The placement, shape and structure of the one or more handles 420 is not particularly limited and may have any configuration, which may be apparent to a person or ordinary skill in the art. The vertical portion 405 may also have one or more windows 425 formed there in. In some implementations, the one or more windows 425 may be formed from a transparent Anti-Ballistic material such as a bullet resistant glass or polycarbonate material such as materials sold by Saint-Gobain under the trade names “Diamant” and/or “security glass”, which are typically used in commercial armored vehicles and security trucks. Alternatively, the transparent Anti-Ballistic material may be a Sapphire material. Other similar materials or configurations of materials with similar purpose and function may be readily apparent to a person of ordinary skill in the art.

The movable barrier 400 may also include a base portion 430, which flairs outward with a greater depth than the vertical portion 405 to provide stability to the movable barrier 400. In some example implementations, the base portion 430 may include wheels, legs, rails, a fairing or skirt 435 that covers a lower structure (illustrated and discussed in greater detail below). In some example implementations, the base portion 430 may also include a storage compartment 440 for housing goods therein. For example, Anti-Ballistic defense accessories or components may be stored in the storage compartment.

FIG. 5 is an exploded view of the movable barrier 400 of FIG. 4. As illustrated, the vertical portion 405 includes an internal frame 445 to provide a structure for the windows 425 to be mounted to. The material construction of the internal frame 445 is not particularly limited and may include any material that may be apparent to a person of ordinary skill in the art. For example, the internal frame 445 may be formed from an aluminum alloy, a steel alloy, a composite material, a resin material or any other material that may be apparent to a person of ordinary skill in the art.

Within the vertical portion 405, a plurality of Anti-Ballistic Panels 450 arranged within the internal frame 445 to provide a contiguous Anti-Ballistic structure with the windows 425. In some example implementations, the Anti-Ballistic Panels 450 may have a configuration similar to the Anti-Ballistic Panels 100, 200, 300 illustrated in FIGS. 1-3 discussed above. However, example implementations are not limited to this configuration and may have alternative configurations that may be apparent to a person ordinary skill in the art.

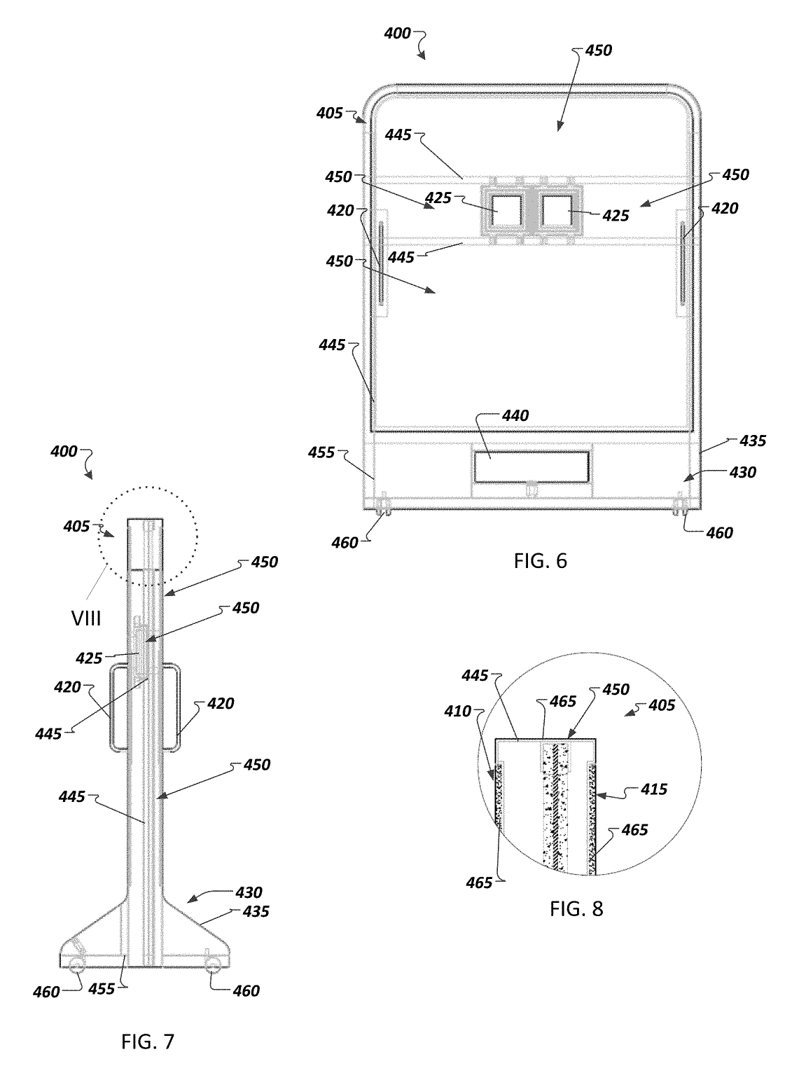

FIGS. 6 and 7 are cross-sectional views of the movable barrier of FIG. 4. As illustrated, the internal frame 445 supports the supports the windows 425 and provides supports the Anti-Ballistic Panels 450 around the windows to form a contiguous Anti-Ballistic structure along the entire length of the movable barrier 400. FIGS. 6 and 7 also illustrate that the base portion 430 includes a lower frame 455 beneath the faring 435. The lower frame 455 may have triangle cross-section or T-cross-section to provide stability to the movable barrier 400. The material construction of the lower frame 455 is not particularly limited and may include any material that may be apparent to a person of ordinary skill in the art. For example, the lower frame 455 may be formed from an aluminum alloy, a steel alloy, a composite material, a resin material or any other material that may be apparent to a person of ordinary skill in the art. Further, a plurality of wheels or roller bearings 460 may be attached to the lower frame 455 to allow movement of the movable barrier 400. The wheels or roller bearings 460 are not particularly limited and may include any type of wheel or roller bearing that may be apparent to a person ordinary skill in the art.

FIG. 8 is an enlarged view of the portion (VIII) of FIG. 7. As illustrated, the internal frame 445 includes a plurality of grooves or slots 465 that support the various components of the vertical portion 405 of the movable barrier 400. For example, FIG. 7 illustrates that the front and back surfaces 410 and 415 are each supported in separate grooves or slots 465 of the internal frame 445. Further, the Anti-Ballistic Panel 450 is centrally located in a third groove 465 provide in the middle of the vertical portion 405 of the movable barrier 400.

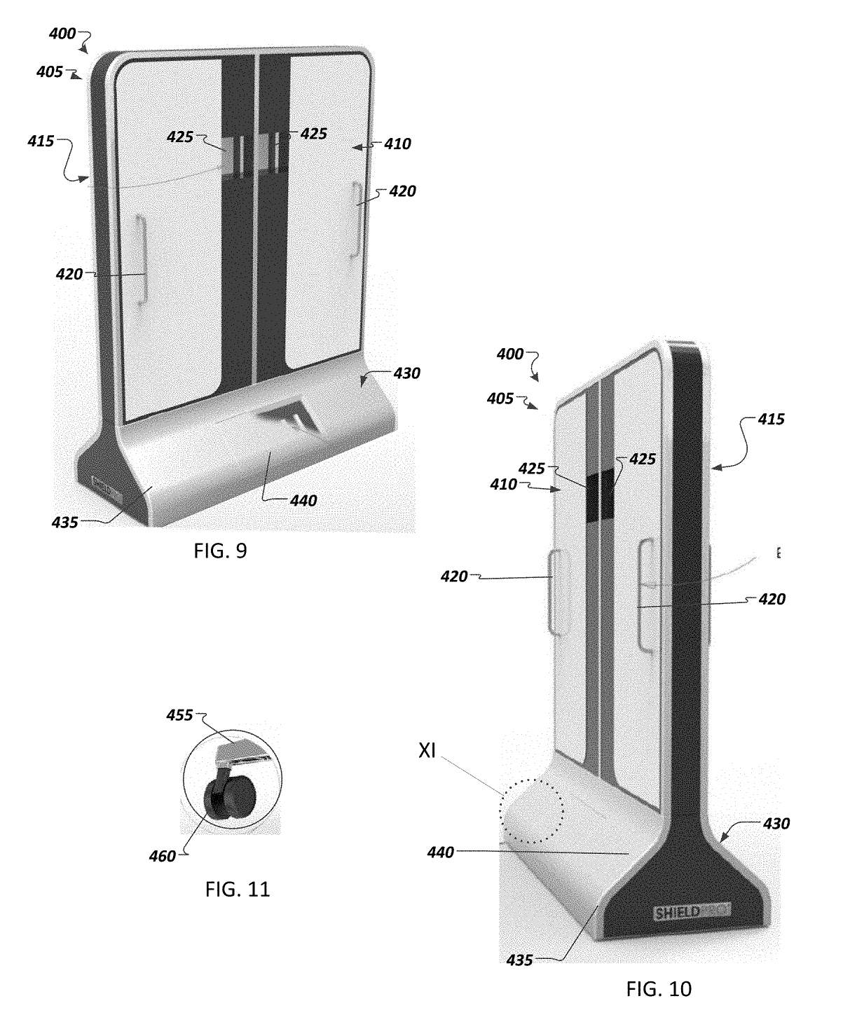

FIGS. 9 and 10 are perspective views of an example implementation of the movable barrier 400 of FIG. 4. Again as discussed above, the movable barrier 400 includes a vertical portion 405 and a base portion 430. The vertical portion includes front and rear surfaces 410, 415; one or more handles 420 and one or more windows 425, which may be formed from transparent Anti-Ballistic material as discussed above. Though not illustrated in FIGS. 9 and 10, the vertical portion also includes an internal frame 445 and a plurality of Anti-Ballistic Panels 450 to form a contiguous Anti-Ballistic structure with the windows 425. The front and rear surfaces 410 and 415 may be customized with different materials depending on a desired application. For example, as discussed above, the front and rear surfaces 410 and 415 may be customized with a variety of materials including push pin material, or writing surface material. Further, the front and rear surfaces 410 and 415 could also be customized with a variety of images, logos, or other material depending on the application of the movable barrier 400.

Further, the base portion 430 includes a faring or skirt 435 and a storage compartment 440 for housing goods therein. Similar to the front and rear surfaces 410 and 415, the faring or skirt 435 may be customized with different materials depending on a desired application. For example, the skirt or faring 435 could be customized with a variety of images, logos, or other material depending on the application of the movable barrier 400.

Further, FIG. 11 illustrates an internal view of a portion (XI) of FIG. 10 beneath the skirt 430 of the movable barrier 400. As illustrated, the lower portion 430 also includes a lower frame 455 providing a wide base for the movable barrier 400 and a plurality of wheels or roller bearings 460 under the skirt 430.

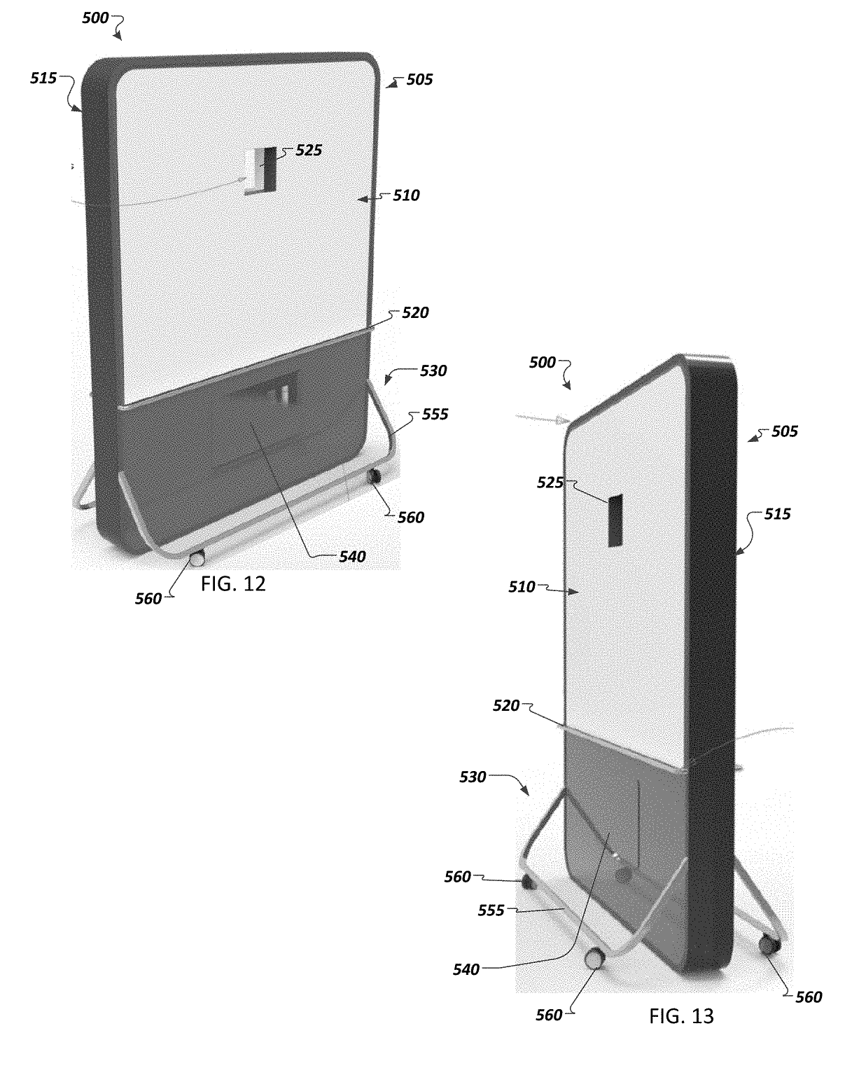

FIGS. 12 and 13 are perspective views of a movable barrier 500 according to a second embodiment of the present application. The movable barrier 500 may include similar aspects to those discussed above with respect to the movable barrier 400 illustrated in FIGS. 4-11. Therefore, similar reference numerals may be used. For example, the movable barrier 500 may include a vertical portion 505 and a base portion 530. The vertical portion may include front and rear surfaces 510 & 515, one or more handles 520, and one or more windows 525, which may be formed from transparent Anti-Ballistic material, like the windows 425 of the movable barrier 400 discussed above. Though not illustrated, the vertical portion may also include an internal frame and a plurality of Anti-Ballistic Panels to form a contiguous Anti-Ballistic structure with the windows 525, like the movable barrier 400 discussed above. The front and rear surfaces 510 and 515 may also be customized with different materials depending on a desired application. For example, as discussed above, the front and rear surfaces 510 and 515 may be customized with a variety of materials including magnets push pin material, or writing surface material. Further, the front and rear surfaces 510 and 515 could also be customized with a variety of images, logos, or other graphic design materials depending on the application of the movable barrier 500.

The base portion 530 of the movable barrier 500 includes a lower frame 555 providing a wide base for the movable barrier 500 and a plurality of wheels or roller bearings 560 under the skirt 530. The base portion 530 also includes a storage compartment 540 for housing goods therein. However, unlike the movable barrier 400 discussed above, the base portion 530 of the movable barrier 500 does not include a faring or skirt.

Further, Anti-Ballistic Panels according to one or more embodiments of the present application may also be used as a non-moveable barrier with an internal frame; and at least one Anti-Ballistic Panel attached to the internal frame as described above. Further, the front and back surfaces 410 and 415 may also include magnets, push pin or bulletin board material, or may be treated to provide a writing surface (such as a dry erase board surface, or a chalkboard surface). For example, the front and back surfaces 410 and 415 can display building information such as a map or advertisement.

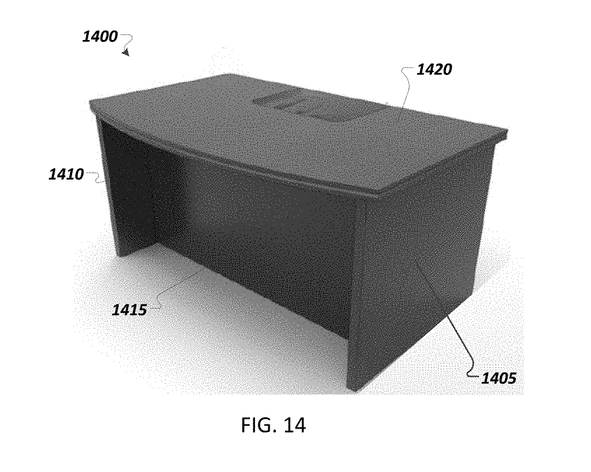

FIG. 14 illustrate another application of the Anti-Ballistic Panels 100, 200, 300 discussed herein. FIG. 14 is a perspective view of furniture 1400 using the Anti-Ballistic Panels according to embodiments of the present application. As illustrated, the furniture 1400 is a desk having a right panel 1405, a left panel 1410, a central panel 1415, and a top 1420. Anti-Ballistic Panels, such as those described herein could be used to construct one or more of the right panel 1405, the left panel 1410, the central panel 1415, and the top 1420. Alternatively, Anti-Ballistic Panels according to one or more embodiments of the present application could be attached to the inner surfaces or outer surfaces of one or more of one or more of the right panel 1405, the left panel 1410, the central panel 1415, and the top 1420. Similarly, Anti-Ballistic Panels according to one or more embodiments of the present application could be used to constructed any piece of furniture that may be apparent to a person of ordinary skill in the art, or may be attached to surfaces of any piece of furniture as may be apparent to a person of ordinary skill in the art to provide Anti-Ballistic protection.

Further, Anti-Ballistic Panels according to one or more embodiments of the present application may also be used in building construction or building retrofitting to provide Anti-Ballistic protection. For example, Anti-Ballistic Panels according to one or more embodiments of the present application may be incorporated into the offices or doors of a building during construction. Similarly, Anti-Ballistic Panels according to one or more embodiments of the present application may be retrofitted to be attached to the inner walls and/or doors of an existing building to provide the same Anti-Ballistic protection.

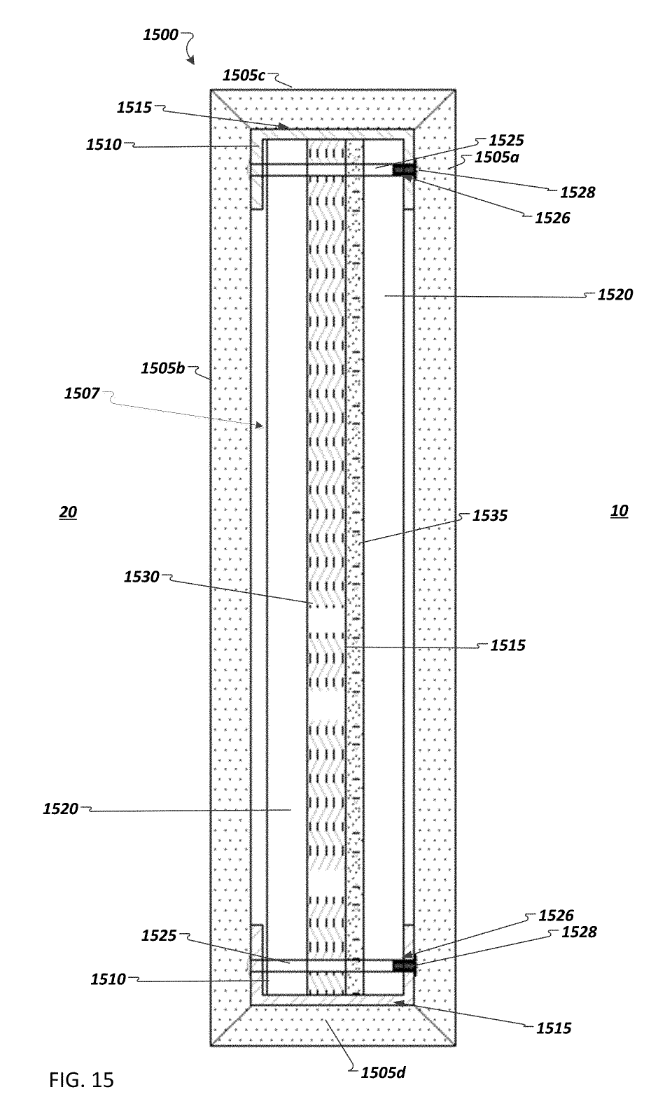

FIG. 15 is a cross-section of an Anti-Ballistic Panel 1500 according to a fourth embodiment of the present application. As illustrated, one side 10 of the Anti-Ballistic Panel 1500 may be considered an exterior side or active side that may be oriented outward or toward an anticipated ballistic source. For example, the exterior side 10 may be oriented to face out from a wall or may face outward from furniture incorporating the Anti-Ballistic Panel 1500. Conversely, the other side 20 of the Anti-Ballistic Panel 100 may be considered an interior side or passive side that may be oriented inward or away from an anticipated ballistic source. For example, the interior side 20 may be oriented to face inward toward a wall or may face inward from furniture incorporating the Anti-Ballistic Panel 1500.

The Anti-Ballistic Panel 1500 may include a plurality of structural layers 1505a-1505d providing structure and rigidity to the panel by forming void 1507 within the plurality of structural layers 1505a-1505d. Structural layer 1505a may be the structural layer closest to the active side 10 of the Anti-Ballistic Panel. Structural layer 1505b may be the structural layer closest to the passive side 10 of the Anti-Ballistic Panel. Further, structure layers 1505c and 1505d may be endcaps connecting the structural layer 1505a to the structural layer 1505b to enclose the void 1507

In some embodiments, the structural layers 1505a-1505d may be formed from wood, medium density fiberboard, or any other material that may be apparent to a person of ordinary skill in the art to use for structural support. Further, in some embodiments, the structural layers 1505a-1505d may be formed from compressed wood, plywood or other engineered wood materials that may be apparent to a person of ordinary skill in the art. Such materials may provide an increased resistance to warping. The thickness of the structural layers 1505a-1505d is not particularly limited and may be any thickness that may be apparent to a person of ordinary skill in the art. For example, the structural layers 1505a-1505d may have a thickness of three-quarters (¾) of an inch.

The Anti-Ballistic Panel 1500 may also include one or more u-channel members 1510 to which the plurality of structural layers 1505a-1505d may be attached with an adhesive 1515 or other attachment mechanism. In some embodiments, the u-channel members 15109 may be formed from aluminum, titanium or other metal or an alloy thereof. Further, in some embodiments, the adhesive 1515 may be a two-part epoxy or other suitable industrial grade adhesive that may be apparent to a person of ordinary skill in the art.

The Anti-Ballistic Panel 100 may also include a pair of elastomeric layers 1520 oriented on the exterior sides of the void 1507 formed within the plurality of structural layers 1505a-1505d. In some example embodiments, the elastomeric layer 1520 may be a polyethylene foam material or other closed-cell foam material that may be apparent to a person ordinary skill in the art. Further in some embodiments, the elastomeric layer 1510 may have a thickness of three-quarters (¾) of an inch or thicker. However, embodiments of the present application are not limited to this configuration.

Further, a binding post 1525 may be inserted through each u-channel member 1510 and the elastomeric layers 1520 to hold the elastomeric layers 1520 in place. In some example implementations, the binding post may be threaded at one end 1526 and fitted with a bolt 1528 to provide a compression force along the length of the binding post 1525. Additionally, in some example implementations, the binding post 1525 may be formed from a metal such as aluminum, titanium or any other metal or alloy that may be apparent to a person of ordinary skill in the art. In other example implementations, the binding post 1525 (or bolt) may be formed from steel and other materials that may be apparent to a person of ordinary skill in the art.

The Anti-Ballistic Panel 1500 may also include an Anti-Ballistic Portion or Anti-Ballistic layer 1530 located between the pair of the elastomeric layers 1530. In some embodiments, the Anti-Ballistic Portion 1530 may be formed from aramid fibers. For example the Anti-Ballistic Portion 1530 may be formed from plurality layers, each layer being formed from aramid fibers laid parallel to each other. Further, adjacent layers of the Anti-Ballistic Portion 1530 may be oriented such that the fibers of the adjacent layers are angled with respect to each other. For example, fibers of adjacent layers may form a 90° with respect to each other. In other embodiments, the angle may be an angle other than 90° (e.g. 45°, 60°, 75°, or any other angle that may be apparent to a person of ordinary skill in the art.

It must be fully understood at this time that different Anti-Ballistic materials can be used for the purpose of constructing the Anti-Ballistic Portion 1530 including a variety of soft materials along with hard surfaced resin impregnated laminated Anti-Ballistic materials some of which are sold by Du Pont under the registered trademark KEVLAR® and will still remain within the scope of this application. Additionally, the Anti-Ballistic Portions of the Anti-Ballistic Portion 1530 may be fabricated using not only aramid fibers and KEVLAR® from DuPont, but also polyethylene fibers and GOLD SHIELD®, which is a KEVLAR® based material, and SPECTRA SHIELD®, which is polyethylene based material, both available commercially from Honeywell. GOLD SHIELD® and SPECTRA SHIELD® are high strength synthetic fibers impregnated in partially cured resin for use in ballistic material. Moreover, both of the Honeywell materials can be used as layered soft armor as well as hard armor when they are autoclaved or compression molded into Anti-Ballistic components for construction of the Anti-Ballistic Portion 1530, as shown and described. Other similar materials of like purpose and function are also anticipated by this disclosure.

In some embodiments, the Anti-Ballistic Portion 1530 may have a thickness of eleven-sixteenths (0.6875) of an inch. Further, in some example embodiments, each of the binding posts 1525 may also be inserted through a portion of the Anti-Ballistic Portion 1530 to hold the Anti-Ballistic Portion 1530 in place. However, embodiments of the present application are not limited to this configuration and may have other configurations that may be apparent to a person of ordinary skill in the art.

Further, in some example implementations, the Anti-Ballistic Panel 1500 may also include a ceramic blast plate 1535 located next to the Anti-Ballistic Portion 1530. In some example implementations, the ceramic blast plate may be located on a side of the Anti-Ballistic Portion 1530 closer to active side 10 of the Anti-Ballistic Panel 1500 as illustrated in FIG. 15. Further, in some example embodiments, each of the binding posts 1525 may also be inserted through a portion of the ceramic blast plate 1535 to hold the ceramic blast plate 1535 in place. Further, in some example implementations, the ceramic blast plate 1535 may also attached to the Anti-Ballistic Portion 1530 another layer of the adhesive 1515. However, example implementations are not limited to these configurations.

The ceramic blast plate 1535 may be formed from a variety of hardened ceramic or silicon carbide materials.

In example implementation of FIG. 15, the elastomeric layers 152-, Anti-Ballistic Portion 1530 and the ceramic blast plate 1535 are illustrated being placed relative to each other by the binding posts 1525. However, example implementations are not limited to this configuration and in some implementations, the elastomeric layers 152; the Anti-Ballistic Portion 1530 and the ceramic blast plate 1535 may “float” in void 1507. In other words, the elastomeric layers 1520 may not be attached to any one of the other layers and components illustrated in FIG. 15. Similarly, Anti-Ballistic Portion 130 may not be attached to any one of the other layers and components illustrated in FIG. 15, but still be retained within the avoid 1507. In these configurations, the size of the void 1507 may be sized such that the elastomeric layers 1510 and the Anti-Ballistic Portion 1530 are snugly held in place. Further, in some configurations, the void 1507 may be sized such that the elastomeric layers 1520 are slightly compressed (5-10% or more) when the Anti-Ballistic Panel 1500 is fully assembled.

Again, as previously described, the Anti-Ballistic Portions of the Anti-Ballistic Panels may be fabricated using not only aramid fibers and KEVLAR® from DuPont, but also polyethylene fibers and GOLD SHIELD,® which is a KEVLAR® based material, and SPECTRA SHIELD,® which is polyethylene based material both available commercially from Honeywell. GOLD SHIELD® and SPECTRA SHIELD® are high strength synthetic fibers impregnated in partially cured resin for use in ballistic material. Moreover, both of the Honeywell materials can be used as layered soft and/or as well as hard armor when they are autoclaved or compression molded into Anti-Ballistic components for construction of the Anti-Ballistic Panels, as shown and described. Other similar materials of like purpose and function are also anticipated by this disclosure. Additionally, in some embodiments an Anti-Ballistic Panel may be a hard armor panel in some portions of a barrier or piece of furniture and a soft armor panel in other portions of a barrier or piece of furniture.

The Anti-Ballistic Panels, barriers, and furniture shown in the drawings and described in detail herein disclose arrangements of elements of particular construction and configuration for illustrating embodiments of structure and method of operation of the present application. It is to be understood, however, that elements of different construction and configuration and other arrangements in accordance with the spirit of this thereof other than those illustrated and described may be employed for providing disclosure, and such changes, alternations and modifications as would occur to those skilled in the art are considered to be within the scope of this design as broadly defined in the appended claims.

The abstract and any summaries provided herein are not intended to limit the scope of the present application, which is measured by the claims.

We claim:

1. An Anti-Ballistic Panel comprising:
a first structural layer;
a second structural layer;
a first Anti-Ballistic layer disposed between the first structural layer and the second structural layer; and
an elastomeric layer disposed between the first structural layer and the Anti-Ballistic layer.

2. The Anti-Ballistic Panel of 1, further comprising:
a second Anti-Ballistic layer disposed between the elastomeric layer and the first structural layer.

3. The Anti-Ballistic Panel of 1, wherein at least one of the first structural layer and the second structural layer is formed from an engineered wood material.

4. The Anti-Ballistic Panel of 1, wherein the first Anti-Ballistic layer is formed using Aramid fibers.

5. The Anti-Ballistic Panel of 1, wherein the elastomeric layer is closed-cell foam material.

6. A piece of furniture comprising at least one side formed from the Anti-Ballistic Panel of 1.

7. A moveable barrier comprising:
an internal frame; and
at least one Anti-Ballistic Panel attached to the internal frame.

8. The moveable barrier of 7, wherein the Anti-Ballistic Panel comprises:
a first structural layer;
a second structural layer;
a first Anti-Ballistic layer disposed between the first structural layer and the second structural layer; and
an elastomeric layer disposed between the first structural layer and the Anti-Ballistic layer.

9. The moveable barrier of 7, further comprising an Anti-Ballistic Window attached to the internal frame.

10. The movable barrier of 7, further comprising a lower frame attached to the internal frame.

11. The movable barrier of 10, further comprising at least one wheel attached to the lower frame.

12. The movable barrier of 10, further comprising a faring disposed over the lower frame.

13. The moveable barrier of 10, wherein the lower frame defines a storage area beneath the internal frame.

14. A non-moveable barrier comprising:
an internal frame; and
at least one Anti-Ballistic Panel attached to the internal frame.
